(19) United States
(12) Patent Application Publication
(10) Pub. No.: US 2026/0279852 A1
(43) Pub. Date: Sep. 17, 2026

(54) FUEL CELL INCLUDING SEALING MEMBER WITH ACID-MODIFIED OLEFIN ADHESIVE LAYER CONTAINING METAL DEACTIVATOR

(71) Applicants: Takahiro INATOMI, Toyota-shi (JP); Makoto IMAHORI, Tokyo (JP); Masataka OJIKA, Tokyo (JP)

(72) Inventors: Takahiro INATOMI, Toyota-shi (JP); Makoto IMAHORI, Tokyo (JP); Masataka OJIKA, Tokyo (JP)

(73) Assignees: TOYOTA JIDOSHA KABUSHIKI KAISHA, Toyota-shi (JP); TOAGOSEI CO., LTD., Tokyo (JP)

(21) Appl. No.: 19/556,025

(22) Filed: Mar. 4, 2026

(30) Foreign Application Priority Data
Mar. 14, 2025 (JP) 2025-041702

(51) Int. Cl. H01M 8/0284

(52) U.S. Cl. CPC H01M 8/0284

(57) ABSTRACT

The present disclosure provides a fuel cell having a sealing member having a high sealing performance even in a high temperature and highly acidic environment. One aspect of the present disclosure relates to a fuel cell including a sealing member. The fuel cell including a sealing member includes a substrate layer, a tie layer arranged on a surface of the substrate layer, and an acid-modified olefin adhesive layer that is arranged on a surface of the tie layer and contains a metal deactivator. The acid-modified olefin adhesive layer contains the metal deactivator in an amount in a range of from 300 ppm to 8,000 ppm. The metal deactivator is a compound represented by Formula (I):

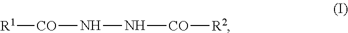

In the formula, R¹ and R² are each independently a monovalent group containing a substituted or unsubstituted aryl.

### CROSS REFERENCE TO RELATED APPLICATIONS

The present application claims priority from Japanese patent application JP 2025-041702 filed on Mar. 14, 2025, the entire content of which is hereby incorporated by reference into this application.

### BACKGROUND

### Technical Field

The present disclosure relates to a fuel cell including a sealing member with an acid-modified olefin adhesive layer containing a metal deactivator.

### Background Art

A fuel cell stack obtains electric power by electrochemically reacting hydrogen with oxygen. The product produced in association with the power generation of the fuel cell stack is, in principle, only water. Therefore, the fuel cell stack is attracting attention as a clean power generation system with almost no impact on the global environment.

The fuel cell stack includes a membrane electrode assembly (hereinafter also referred to as “MEA”), in which electrode catalyst layers are arranged on both surfaces of an electrolyte membrane, as a basic unit. During operation of the fuel cell stack, a fuel gas containing hydrogen is supplied to the electrode catalyst layer at an anode (fuel electrode) side, and an oxidizing gas containing oxygen is supplied to the electrode catalyst layer at a cathode (air electrode) side, thereby generating an electromotive force. An oxidation reaction proceeds at the anode while a reduction reaction proceeds at the cathode, thereby supplying the electromotive force to an external circuit.

In the fuel cell stack, typically, gas diffusion layers are arranged outside the respective electrode catalyst layers of MEA, and separators are further arranged outside the gas diffusion layers, thus constituting a fuel cell. The fuel cell stack is usually used as a combination of a plurality of fuel cells required based on a desired electric power, and the fuel cell is usually used as a single cell.

The separator not only separates the fuel gas and air supplied to the respective fuel cells, but also functions as a current transmission unit to the outside. Therefore, the fuel cell usually includes a sealing member that blocks the fuel gas and air at the separator.

For example, JP 2014-160609 A discloses a sealing material for a fuel cell separator including a separator substrate, a first primer layer, a second primer layer, and an elastomeric seal layer. The first primer layer is formed by firing an organometallic compound. The second primer layer is formed by firing an organosilicon compound having an Si—H group. The elastomeric seal layer is a cured layer of a liquid addition-curable silicone rubber composition containing alkenyl groups and Si—H functional groups.

### SUMMARY

As described above, the sealing member for use in a fuel cell was developed. However, the conventional sealing member for a fuel cell has a problem with corrosion resistance under acidic conditions. In fuel cell stack usage environments, the separator or the sealing member included in the fuel cell is exposed to a high temperature and highly acidic environment. For the separator main body, the corrosion can be suppressed by a surface treatment and the like. On the other hand, at the adhesive portion of the separator with the sealing member, the surface of the separator substrate is exposed to ensure the adhesion to the sealing member. Therefore, the exposed surface of the separator substrate corrodes in the high temperature and highly acidic environment, and may be dissolved as metal ions. The metal ions dissolving from the separator substrate may cause deterioration of the sealing member. Thus, when the fuel cell is exposed to the high temperature and highly acidic environment, it is difficult to maintain the sealing performance of the sealing member over a long period of time.

Therefore, the present disclosure provides a fuel cell including a sealing member having a high sealing performance even in a high temperature and highly acidic environment.

The inventors examined various means to solve the problem. The inventors found that in a sealing member for a fuel cell, an acid-modified olefin adhesive layer containing a metal deactivator, such as a chelating agent, capable of adsorbing metal ions allows maintaining the adhesion over a long period of time even in a high temperature and highly acidic environment. The inventors completed the present disclosure based on the findings.

That is, the present disclosure includes the following aspects and embodiments.
(Embodiment 1) A fuel cell having a sealing member includes a substrate layer, a tie layer arranged on a surface of the substrate layer, and an acid-modified olefin adhesive layer that is arranged on a surface of the tie layer and contains a metal deactivator. The acid-modified olefin adhesive layer contains the metal deactivator in an amount in a range of from 300 ppm to 8,000 ppm. The metal deactivator is a compound represented by Formula (I):

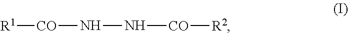

in the formula, R¹ and R² are each independently a monovalent group containing a substituted or unsubstituted aryl.
(Embodiment 2) In the fuel cell according to the embodiment 1, R¹ and R² are each independently a substituted or unsubstituted aryl, a substituted or unsubstituted aryl-CO—NH—NH—CO-alkyl, or a substituted or unsubstituted arylalkyl.
(Embodiment 3) In the fuel cell according to the embodiment 1 or 2, R¹ and R² are each independently phenylethyl substituted with one or more hydroxyl or alkyl.
(Embodiment 4) In the fuel cell according to any of the embodiments 1 to 3, R¹ and R² are (3,5-di-tert-butyl-4-hydroxyphenyl)ethyl.
(Embodiment 5) In the fuel cell according to any of the embodiments 1 to 4, the acid-modified olefin adhesive layer contains the metal deactivator in an amount in a range of from 375 ppm to 6,000 ppm.

The present disclosure makes it possible to provide the fuel cell including the sealing member having the high sealing performance even in the high temperature and highly acidic environment.

### BRIEF DESCRIPTION OF THE DRAWINGS

FIG. 1 is a cross-sectional view of one embodiment of a sealing member included in a fuel cell according to one aspect of the present disclosure;

FIG. 2 is a graph illustrating a relation between a treatment time and an adhesion retention rate for each test specimen in a hot water peel test (1) after an acid treatment, where the horizontal axis indicates the treatment time (hour) and the vertical axis indicates the adhesion retention rate (%); and

FIG. 3 is a graph illustrating a relation between an amount of a chelating agent (2) contained in an acid-modified olefin adhesive layer and an adhesive strength of the acid-modified olefin adhesive layer in a hot water peel test (2) after the acid treatment, where the horizontal axis indicates the amount (ppm) of the chelating agent (2) and the vertical axis indicates the adhesive strength (N/10 mm).

### DETAILED DESCRIPTION

The following describes embodiments of the present disclosure in detail.

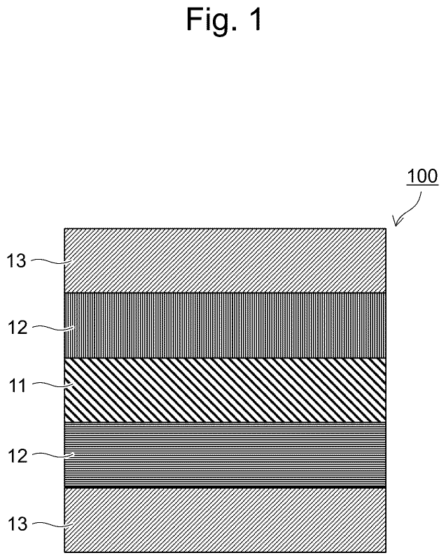

One aspect of the present disclosure relates to a fuel cell including a sealing member. FIG. 1 illustrates a cross-sectional view of one embodiment of the sealing member included in the fuel cell of the one aspect of the present disclosure. The following describes the sealing member included in the fuel cell of this aspect with reference to the drawings.

As illustrated in FIG. 1, a sealing member 100 included in the fuel cell of this aspect includes a substrate layer 11, tie layers 12 arranged on surfaces of the substrate layer 11, and acid-modified olefin adhesive layers 13 arranged on surfaces of the tie layers 12. The sealing member 100 typically has a plate or sheet shape. The tie layer 12 and the acid-modified olefin adhesive layer 13 may be arranged on only one surface of the substrate layer 11, or may be arranged on both surfaces of the substrate layer 11. The acid-modified olefin adhesive layer 13 contains a metal deactivator.

The inventors found that in a sealing member for a fuel cell, an acid-modified olefin adhesive layer containing a metal deactivator, such as a chelating agent, capable of adsorbing metal ions allows maintaining the adhesion over a long period of time even in a high temperature and highly acidic environment. Therefore, the sealing member having the above-described configuration included in the fuel cell of this aspect can have the high sealing performance even in the high temperature and highly acidic environment.

In the sealing member included in the fuel cell of this aspect, the substrate layer is stainless steel, a titanium alloy, or an aluminum alloy in some embodiments, and is stainless steel in some embodiments. Because of the relatively low price and the sufficient strength and workability, the above-described materials are appropriate for the substrate of the sealing member for the fuel cell.

In the sealing member included in the fuel cell of this aspect, the tie layer is a layer for improving the adhesion between the substrate layer and the acid-modified olefin adhesive layer. The material constituting the tie layer can be appropriately selected by those skilled in the art based on the combination of the materials of the substrate layer and the acid-modified olefin adhesive layer. The tie layer is formed of a primer used in the technical field in some embodiments.

In the sealing member included in the fuel cell of this aspect, the acid-modified olefin adhesive layer is a layer for ensuring the adhesion to the other members and blocking a fuel gas and air. The material constituting the acid-modified olefin adhesive layer is acid-modified olefin from the aspect of water resistance in some embodiments, and acid-modified polypropylene from the aspect of heat resistance in some embodiments. With the acid-modified olefin adhesive layer including the materials exemplified above, the sealing member included in the fuel cell of this aspect can have the high sealing performance even in the high temperature and highly acidic environment.

In the sealing member included in the fuel cell of this aspect, the metal deactivator contained in the acid-modified olefin adhesive layer is a chelating agent in some embodiments. The chelating agent can adsorb metal ions. Therefore, even when the material of the separator substrate corrodes in the high temperature and highly acidic environment, and may be dissolved as metal ions, the metal deactivator, such as a chelating agent, contained in the acid-modified olefin adhesive layer adsorbs the metal ions, thereby allowing the substantially suppressed reduction of the adhesion. Therefore, with the acid-modified olefin adhesive layer containing the metal deactivator, such as a chelating agent, the sealing member included in the fuel cell of this aspect can substantially suppress the reduction of the adhesion and have the high sealing performance even in the high temperature and highly acidic environment.

The metal deactivator is a compound represented by Formula (I) in some embodiments:

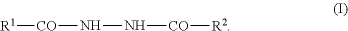

The compound represented by Formula (I) is a chelating agent capable of adsorbing the metal ions. Therefore, with the acid-modified olefin adhesive layer containing the compound represented by Formula (I) as the metal deactivator, the sealing member included in the fuel cell of this aspect can substantially suppress the reduction of the adhesion and have the high sealing performance even in the high temperature and highly acidic environment.

In Formula (I), R¹ and R² are each independently a monovalent group containing a substituted or unsubstituted aryl. R¹ and R² are each independently a substituted or unsubstituted aryl, a substituted or unsubstituted aryl-CO—NH—NH—CO-alkyl, or a substituted or unsubstituted arylalkyl in some embodiments. R¹ and R² are each independently phenyl substituted with one or more hydroxyl, phenyl-CO—NH—NH—CO-alkyl substituted with one or more hydroxyl (alkyl has 1 to 16 carbon atoms, 1 to 12 carbon atoms in some embodiments, and 1 to 10 carbon atoms in some embodiments), or phenylalkyl substituted with one or more hydroxyl or alkyl (alkyl has 1 to 4 carbon atoms, 1 to 3 carbon atoms in some embodiments, and 1 or 2 carbon atoms in some embodiments) in some embodiments. R¹ and R² are each independently phenylethyl substituted with one or more hydroxyl or alkyl in some embodiments, and (3,5-di-tert-butyl-4-hydroxyphenyl)ethyl in some embodiments. With the acid-modified olefin adhesive layer containing the compound represented by Formula (I) having the groups as exemplified above as the metal deactivator, the sealing member included in the fuel cell of this aspect can substantially suppress the reduction of the adhesion and have the high sealing performance even in the high temperature and highly acidic environment.

In the sealing member included in the fuel cell of this aspect, the amount of the metal deactivator contained in the acid-modified olefin adhesive layer is in a range of from 300 ppm to 8,000 ppm, in a range of from 300 ppm to 6,000 ppm in some embodiments, and in a range of from 375 ppm to 6,000 ppm in some embodiments. When the amount of the metal deactivator contained in the acid-modified olefin adhesive layer is less than the lower-limit value, the adhesion possibly reduces in the high temperature and highly acidic environment. When the amount of the metal deactivator contained in the acid-modified olefin adhesive layer is increased beyond the upper-limit value, there is a possibility of causing no substantial difference in the effect of suppressing the reduction of the adhesion in the high temperature and highly acidic environment. Therefore, with the acid-modified olefin adhesive layer containing the metal deactivator in the amount in the range exemplified above, the sealing member included in the fuel cell of this aspect can substantially suppress the reduction of the adhesion and have the high sealing performance even in the high temperature and highly acidic environment.

In each aspect of the present disclosure, the sealing performance of the sealing member included in the fuel cell in the high temperature and highly acidic environment can be evaluated by, for example, the following test. Test specimens of the fuel cell separator or its sealing member are immersed in an acidic solution (for example, pH 2 or less) and heated under conditions of high temperature (for example, 100° C. or higher) and a certain period of time. The treated test specimens are collected, and the surface state is visually observed. Alternatively, a hot water peel test is performed on the treated test specimens according to the following procedure. A heated water bath provided with a hook on the bottom surface is filled with hot water (for example, at 95° C.). The joint portion (for example, having a width of 10 mm) on the surface of the test specimen before the treatment and the test specimen after the treatment is connected to the hook on the bottom surface. While the test specimen is immersed in the hot water, a tensile load is applied to the test specimen at a constant rate (for example, 30 mm/minute). The tensile load (N) at which the test specimen peels off is recorded as an adhesive strength. The percentage of the adhesive strength of the test specimen after the treatment relative to the adhesive strength of the test specimen before the treatment is calculated as the adhesion retention rate (%) and compared.

As described above in detail, the sealing member included in the fuel cell according to the one aspect of the present disclosure has the high sealing performance even in the high temperature and highly acidic environment. Therefore, the fuel cell of the one aspect of the present disclosure can be appropriately used for the fuel cell stack in the usage of power sources for vehicles, such as automobiles, railways, ships, and aircraft, or power supplies for household or commercial use.

### Examples

The following further specifically describes the present disclosure with examples. However, the technical scope of the present disclosure is not limited to these examples.

### <I: Preparation of Test Specimen>

### [I-1: Preparation of Test Specimen for Corrosion Resistance Test]

A predetermined amount of a chelating agent (1), (2), or (3) was dissolved in a solvent to prepare a chelating agent solution. The chelating agent solution was applied to a stainless steel (SUS) plate serving as an adherend. The SUS plate coated with the chelating agent solution was subjected to heat drying to obtain a test specimen of the SUS plate having a layer containing the chelating agent. A control test specimen containing no chelating agent was obtained by the same procedure except that the chelating agent solution was not applied.

### [I-2: Preparation of Test Specimen for Hot Water Peel Test]

An SUS304 plate (thickness 0.1 mm) serving as an adherend was prepared. An acid-modified polypropylene was blended with a predetermined amount of the chelating agent (1), (2), or (3), and the mixture was melt-kneaded using a twin-screw extruder. From this kneaded product, a monolayer film of an acid-modified olefin adhesive layer having a thickness of 100 μm was produced by a monolayer film-forming machine. The monolayer film was sandwiched between SUS304 plates on both sides and subjected to heat pressing (160° C., 10 seconds, 0.3 MPa) using a precision press machine to produce an assembly. The assembly was cut into strips having a width of 10 mm to obtain test specimens.

Table 1 shows chemical structures of the chelating agents (1), (2), and (3).

TABLE 1

| Chelating Agent | Chemical Structure |
|---|---|
| Chelating Agent (1) | 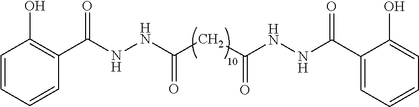 |
| Chelating Agent (2) | 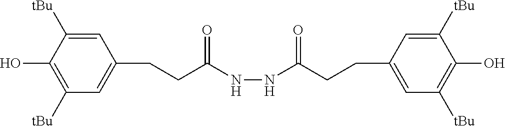 [SMILES: CC(C)(C)c1cc(CCC(=O)NNC(=O)CCc2cc(C(C)(C)C)c(O)c(C(C)(C)C)c2)cc(C(C)(C)C)c1O] |
| Chelating Agent (3) | 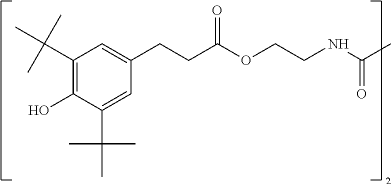 |

### <II: Evaluation of Test Specimen>

### [II-1: Corrosion Resistance Test]

The test specimens produced by the procedure of I-1 were immersed in an acidic solution of pH 2 and heated under conditions at 105° C. for 1340 hours. The treated test specimens were collected, and the surface state was visually observed.

In the control test specimen containing no chelating agent, rust was generated on the surface. In contrast, in the test specimen having a layer containing the chelating agent (1) or (2), no rust was generated on the surface. In the test specimen having a layer containing the chelating agent (3), rust was generated on the surface.

[II-2: Hot Water Peel Test (1) after Acid Treatment]

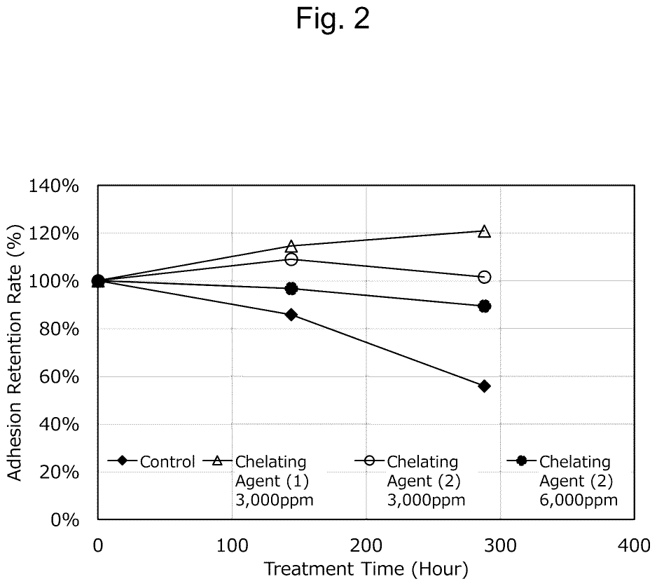

The test specimens produced by the procedure of I-2 were immersed in an acidic solution of pH 2 and heated under conditions at 105° C. for 144 or 288 hours. The treated test specimens were collected. The test specimen before the treatment and the test specimen after the treatment were subjected to a hot water peel test according to the following procedure. A heated water bath provided with a hook on the bottom surface was filled with hot water at 95° C. The joint portion (having a width of 10 mm) on the surface of the test specimen before the treatment and the test specimen after the treatment was connected to the hook on the bottom surface. While the test specimens were immersed in the hot water, a tensile load was applied to the test specimens at a rate of 30 mm/minute. The tensile load (N) at which the test specimen peeled off was recorded as the adhesive strength (N/10 mm). The measurement was performed in triplicate, and the average value was calculated. The percentage of the average value of the adhesive strength of the test specimen after the treatment relative to the average value of the adhesive strength of the test specimen before the treatment was calculated as the adhesion retention rate (%). FIG. 2 illustrates the relation between the treatment time and the adhesion retention rate for each test specimen. In the drawing, the horizontal axis indicates the treatment time (hour), and the vertical axis indicates the adhesion retention rate (%).

As illustrated in FIG. 2, in the control test specimen with the acid-modified olefin adhesive layer containing no chelating agent, the adhesion retention rate decreased as the acid treatment time increased. In contrast, in the test specimen with the acid-modified olefin adhesive layer containing the chelating agent (1) or (2), the adhesion retention rate was substantially maintained even after the acid treatment for 288 hours.

[II-3: Hot Water Peel Test (2) after Acid Treatment]

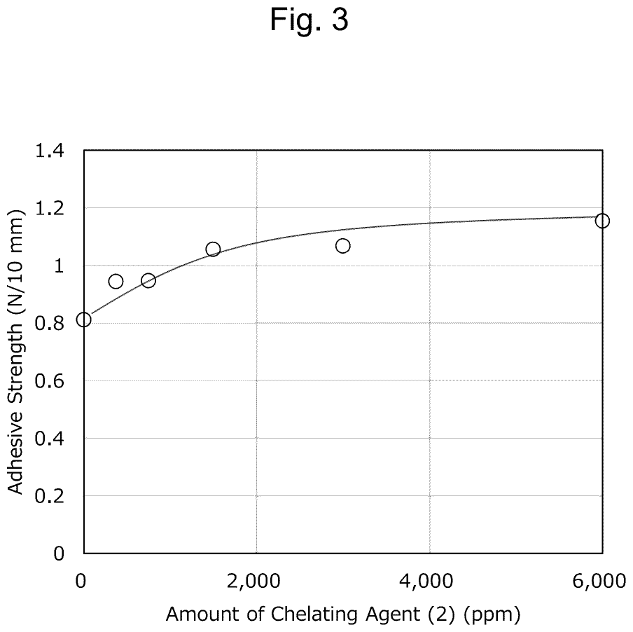

The test specimens with the adhesive layer containing predetermined amounts (375, 750, 1,500, 3,000 or 6,000 ppm) of the chelating agent (2) and the control test specimen produced by the procedure of I-2 were immersed in an acidic solution of pH 2, and heated under conditions at 105° C. for 2016 hours. The treated test specimens were collected. For each test specimen, the adhesive strength (N/10 mm) was measured according to the procedure of the hot water peel test in the above-described II-2. FIG. 3 illustrates the relation between the amount of the chelating agent (2) contained in the acid-modified olefin adhesive layer and the adhesive strength of the acid-modified olefin adhesive layer. In the drawing, the horizontal axis indicates the amount (ppm) of the chelating agent (2), and the vertical axis indicates the adhesive strength (N/10 mm).

As illustrated in FIG. 3, in the test specimens with the acid-modified olefin adhesive layer containing 375 ppm to 6,000 ppm of the chelating agent (2), the adhesive strength was improved compared with the control test specimen with the acid-modified olefin adhesive layer containing no chelating agent. The adhesive strength was improved depending on the amount of the chelating agent (2) contained in the acid-modified olefin adhesive layer.

The present disclosure is not limited to the above-described examples and includes various modifications. For example, the above-described examples are described in detail for ease of understanding of the present disclosure, and are not necessarily limited to those having all of the described configurations. Additionally, one or more portions of the configuration in each embodiment may be added to, deleted, and/or replaced with other configurations.

### DESCRIPTION OF SYMBOLS

100 Sealing member included in fuel cell
11 Substrate layer
12 Tie layer
13 Acid-modified olefin adhesive layer

What is claimed is:

1. A fuel cell having a sealing member, comprising:
a substrate layer;
a tie layer arranged on a surface of the substrate layer; and
an acid-modified olefin adhesive layer that is arranged on a surface of the tie layer and contains a metal deactivator,
wherein the acid-modified olefin adhesive layer contains the metal deactivator in an amount in a range of from 300 ppm to 8,000 ppm, and
wherein the metal deactivator is a compound represented by Formula (I): 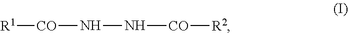
in the formula,
R¹ and R² are each independently a monovalent group containing a substituted or unsubstituted aryl.

2. The fuel cell according to claim 1,
wherein R¹ and R² are each independently a substituted or unsubstituted aryl, a substituted or unsubstituted aryl-CO—NH—NH—CO-alkyl, or a substituted or unsubstituted arylalkyl.

3. The fuel cell according to claim 2,
wherein R¹ and R² are each independently phenylethyl substituted with one or more hydroxyl or alkyl.

4. The fuel cell according to claim 3,
wherein R¹ and R² are (3,5-di-tert-butyl-4-hydroxyphenyl)ethyl.

5. The fuel cell according to claim 1,
wherein the acid-modified olefin adhesive layer contains the metal deactivator in an amount in a range of from 375 ppm to 6,000 ppm.
